(19) United States
(12) Patent Application Publication
(10) Pub. No.: US 2026/0179314 A1
(43) Pub. Date: Jun. 25, 2026

(54) NEURAL LIGHT SAMPLING

(71) Applicant: Advanced Micro Devices, Inc., Santa Clara, CA (US)

(72) Inventors: Jakub Bokšanský, Munich (DE); Holger Gruen, Munich (DE); Daniel Meister, Tokyo (JP)

(73) Assignee: Advanced Micro Devices, Inc., Santa Clara, CA (US)

(21) Appl. No.: 19/000,008

(22) Filed: Dec. 23, 2024

(51) Int. Cl. G06T 15/80; G06T 15/06

(52) U.S. Cl. CPC G06T 15/80; G06T 15/06

(57) ABSTRACT

An important part of graphics rendering is determining lighting, which affects the illumination of objects in a scene. A lighting calculation includes several components, including direct lighting, which is light reflected from a light source across a surface into a camera. Calculating direct lighting is a processing intensive operation since, among other things, it must be determined whether each light source is visible at a particular surface. A technique is provided herein whereby a trained neural network is used to assist with direct lighting calculations. The trained neural network is trained using data from the current scene being rendering. The network accepts a point within the scene as a query and outputs lighting results for the point within the scene. In various examples, the lighting results indicate whether a light is visible from that point or the strength of the light as viewed from that point.

### BACKGROUND

In image synthesis, ray tracing is utilized to find a nearest intersection of a given ray with a scene where light propagation is simulated. Ray tracing is a complex technique that is highly computationally intensive, and improvements to make ray tracing calculations more efficient are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates an example scene in which lighting calculations are performed for ray tracing;

FIG. 6 illustrates an example system for determining lighting for ray tracing;

FIG. 7 illustrates an example set of training operations for a neural network; and

FIG. 8 is a flow diagram of a method for performing ray tracing operations, according to an example.

### DETAILED DESCRIPTION

Ray tracing is a rendering technique whereby rays are cast into a scene and pixels of a render target are colored based on which objects the rays intersect. An important part of ray tracing is determining lighting, which affects the illumination of objects in a scene. A lighting calculation includes several components, including direct lighting, which is light reflected from a light source across a surface into a camera. Calculating direct lighting is a processing-intensive operation since, among other things, it must be determined whether each light source is visible at a particular surface.

A technique is provided herein whereby a trained neural network is used to assist with direct lighting calculations. The trained neural network is trained using data from the current scene being rendering. The network accepts a point within the scene as a query and outputs lighting results for the point within the scene. In various examples, the lighting results indicate whether a light is visible from that point, the intensity of the light incident on that point, or the reflected radiance (intensity of the light reflected at that point into the camera).

In some examples, calculating direct lighting for a point on a surface intersected by a ray involves utilizing the output of the neural network to identify one or more lights to process further for the direct lighting calculation, in a stochastic lighting calculation technique. The stochastic technique includes sampling from a subset of lights with a probability of sampling a particular light based on a relative importance value of that light (which can be, for example, the relative intensity of the light incident at the intersection point). The output of the neural network is used as an input to a selection function, for example to eliminate one or more lights from consideration (e.g., where those lights are indicated as not visible by the neural network), or to determine the relative importance value (with lights indicated by the neural network as having a greater intensity being given a higher importance value than lights indicated as having a lower intensity). Once a light is selected in this manner, the lighting calculation involves determining a contribution of the selected light(s) to the reflected radiance, and, if a stochastic technique is used, normalizing those results based on the estimated proportion of light used in the calculation to the estimated total amount of light if all lights in the scene were sampled.

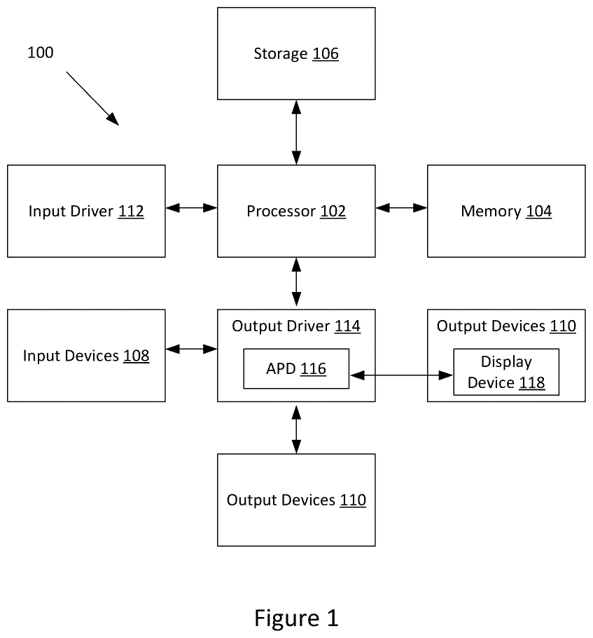

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein. The APD 116 includes APD memory 139, which is available for the compute units 132, and local data share memory 137, which is local to each compute unit 132 and is available to its respective compute unit 132.

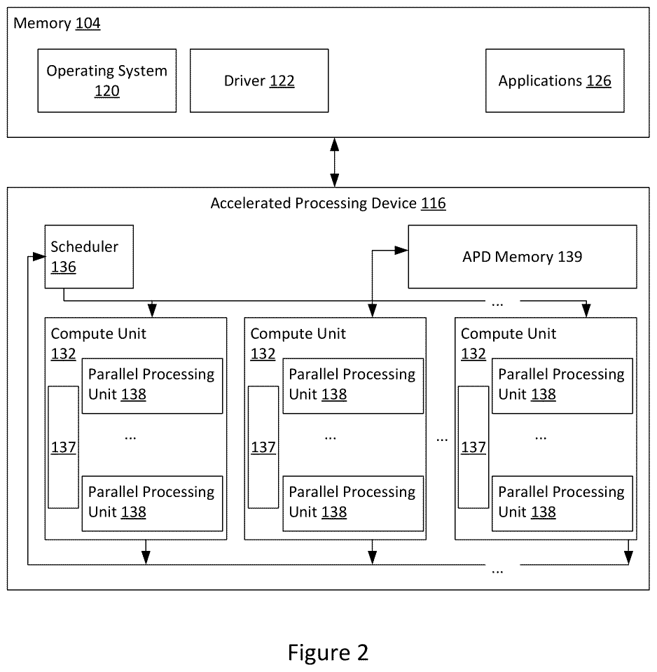

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

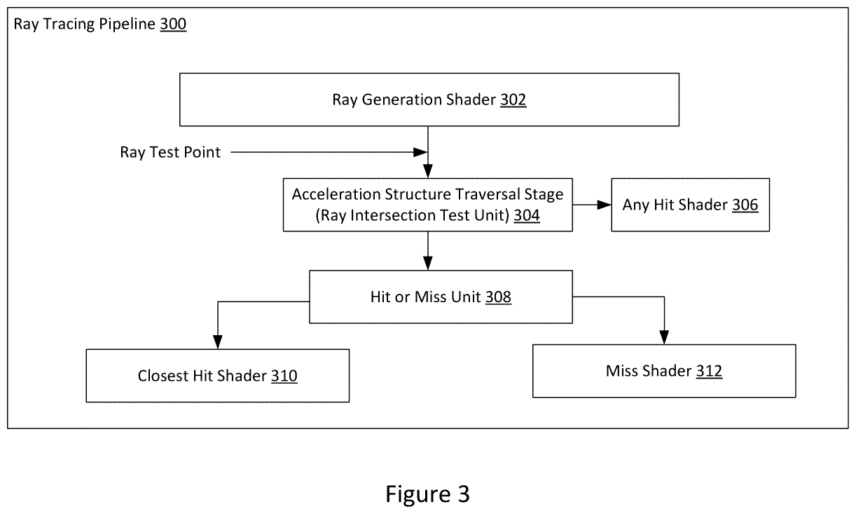

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

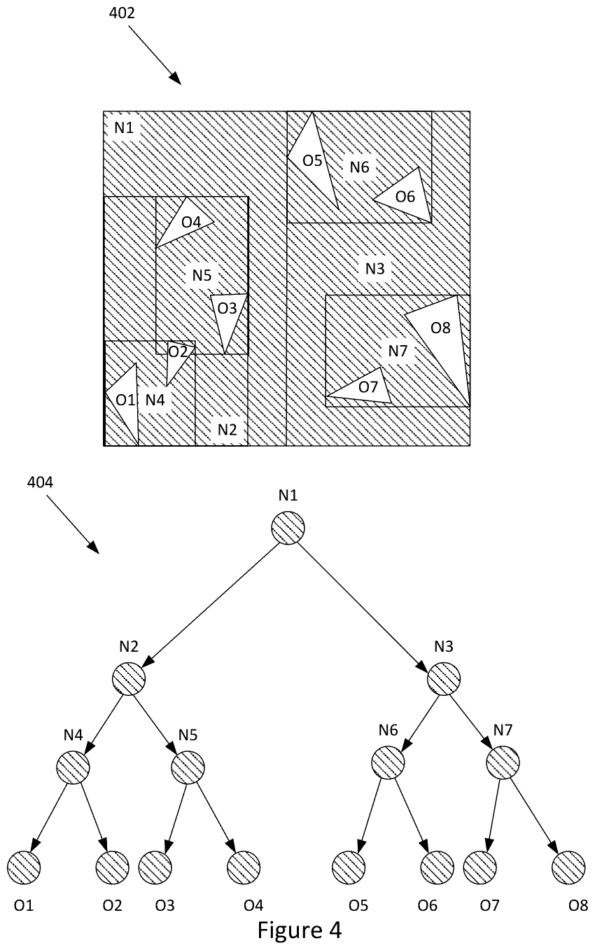

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

Rendering a scene using ray tracing involves calculation of lighting. This lighting is applied to a color such as a color sampled from a material texture to produce a final output color. Lighting calculations are material-dependent and some material types involve calculation of lighting contributions of many different types. For example, materials can have a specular component, a glossy component, and a diffuse component, and can have multiple such components. In addition, each such component can include lighting contributions from many different sources, such as light sources in the scene (direct lighting) as well as light reflected from other objects in the scene (indirect lighting).

Calculating direct lighting typically involves identifying and evaluating lighting intensities from light sources in the scene, and simulating or approximating the reflective effects of the materials of the objects being rendered. For example, specular materials do not scatter light very much (or at all in some approximations), the reflectance of glossy materials can be approximated via a physical approximation to surfaces with “microbumps” that scatter in a variety of directions based on incoming lighting direction and, position on the material, and purely diffuse materials are approximated as scattering light equally in all directions. Light intensities from light sources in the scene take into account whether that light source is occluded by a surface (which therefore casts a shadow onto that surface), and the distance of the light from the surface.

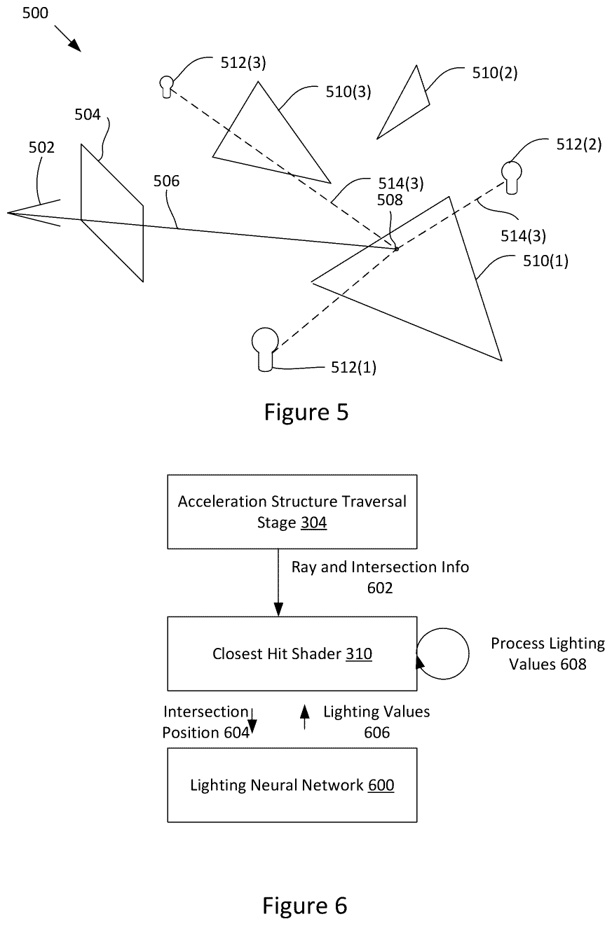

FIG. 5 illustrates an example scene 500 in which lighting calculations are being performed for ray tracing. For this scene, a camera 502 is illustrated, which represents a point of view for rendering. An image plane 504 represents the position of the image being generated by the ray tracing process. In particular, the image plane 504 has a number of pixels. At least one ray 506 is cast per pixel. This ray passes through that pixel and a BVH representing the scene 500 is traversed to identify one or more hits for the ray against primitives in the scene. A final color value for that ray is used to set the color for that pixel. While this process can be complicated and can include evaluation of many surfaces (for example transparent or translucent surfaces), in a simple example, when the ray tracing pipeline 300 identifies a hit on a surface (for example, a closest hit—the closest surface intersected by the ray 506), the ray tracing pipeline 300 calculates lighting and samples a texture for that surface to identify a color for the pixel. There are many techniques to apply lighting to a texture color (or color derived from another source) to generate a color for a pixel. In a simple example, a vector representing the texture color (e.g., with one vector element per color component) is multiplied by a vector representing the lighting (e.g., another vector with one vector element per color component) to obtain an output color as a result.

In some examples, multiple shader programs are involved in this ray tracing process. In an example, a ray generation shader generates the initial ray for a pixel (e.g., ray 506). This ray is to determine the color for the pixel. The ray generation shader triggers traversal of a BVH representing the scene 500. The BVH traversal determines that the ray intersects a point on a particular surface and that such a hit is the closest hit out of all intersections between the ray and primitives and therefore triggers execution of a closest hit shader for the ray. The closest hit shader evaluates the hit to determine a color for the ray 506. This evaluation includes sampling the texture of the intersected surface at the intersection point to obtain a color and also includes evaluating lighting at the intersection point, for the ray 506. Evaluating lighting includes determining a contribution to such lighting from one or more sources, one of which is direct lighting. Evaluating direct lighting includes determining or estimating the reflected radiance contribution from each light source in the scene. The reflected radiance at the intersection point is the amount of light incident at that intersection point that is reflected back to the camera (e.g., in the direction of the ray 506). Material characteristics for a surface define how this reflection occurs at any given point on a surface—for example, simulated micro-bumps may scatter light in various directions depending on the position at which the light is incident.

In one technique, determining the lighting contribution for a particular light source requires determination of whether that light source is occluded by another surface. For example, for a particular point on a surface in a scene, and for a first light source of the light sources in the scene, it is possible that the first light source is occluded by a different surface which is opaque, which would mean that there is no contribution for that first light source to the direct lighting for that pixel. In some examples, determining whether a light source is occluded for a pixel involves casting a shadow ray. A shadow ray is a ray cast from the point of intersection of the original ray (e.g., 506), where the shadow ray travels in the direction of the light source being queried. This ray is cast to determine whether there is any hit with an opaque surface between the light source and the intersection point. In an example, the length of the ray is the distance between the intersection point and the light source and an occlusion occurs if any hit is detected by BVH traversal with an opaque surface between the intersection point and the light source.

Casting a shadow ray for each light source that is sampled to determine visibility is an expensive operation. Therefore, an alternative is provided herein. In particular, a neural network is used to output “lighting values” for each light in the scene given a particular sampling point. In other words, the neural network accepts a point (e.g., a position) in the scene 500 for which it is desired to determine direct lighting information and outputs a lighting value for each light in the scene. In one example, this lighting value for a particular light indicates whether that light is occluded or visible and is thus a binary value (i.e., either 0 or 1, representing invisible (0) or visible (1)). In another example, the lighting value is a continuous parameter that combines visibility and intensity. In this second example, a light that would have high intensity but is nonetheless occluded at a given point will output a low score (e.g., close to 0 or 0) and a light that has high intensity and is visible at the input point is given a high score (e.g., close to 1 or some non-zero value that is proportional to the lighting intensity).

In some examples, when the closest hit shader is executed for the initial ray (e.g., ray 506), that closest hit shader calculates a direct lighting contribution to lighting at the intersection point. Using the technique of the present disclosure, this calculation involves applying the point of intersection as input to the neural network to obtain an output vector. Each element of the output vector corresponds to a different light and indicates the lighting value for that light. The closest hit shader then calculates a direct lighting contribution based on this output.

The closest hit shader calculates the direct lighting contribution based on the output of the neural network in any technically feasible manner. Some examples follow. In one example, in the situation that each element of the output vector indicates whether each a corresponding light is visible or in shadow, the closest hit shader calculates a lighting intensity for each light that is visible (and does not do so for each light that is not visible, or sets the contribution for such light to zero). In an example, such a calculation involves multiplying the inherent intensity of the light (specified by the data for the light itself) by a distance falloff factor (e.g., some factor that reduces intensity by the square of the distance from the position of the light) to obtain an observed light intensity at the intersection point. Then, the closest hit shader applies this value to the material of the intersected surface to obtain a reflected radiance value for the intersection point. The reflected radiance value indicates the amount of light incident from the light source on the intersection point that is actually reflected to the camera (as opposed to in some other direction). A wide variety of techniques are known for calculating reflected radiance based on the light intensity incident on the intersection point. In one example, the material of the intersected surface is represented with a bi-directional reflectance distribution function (“BRDF”) that approximates or indicates how much light is reflected from a surface given the incoming angle and outgoing angle. In some examples, the BRDF indicates a series of micro-bumps for a surface, where each micro-bump has a direction of reflection directions based on angle of incidence of the light with the surface and the direction of the outgoing (reflected light). Evaluation of such a BRDF involves evaluating some approximation of such a surface to obtain the resultant amount of light. By applying the BRDF to the light source, given the relative position of the light source, intersected surface, and camera, it is possible to calculate a reflected radiance.

In another example, each element of the output vector of the neural network represents an intensity of a light source predicted to be observed at the point of intersection (input point to the neural network). This value incorporates both the intensity of the light at that input point as well whether the light is occluded by another surface. Determining the reflected radiance for the intersection point includes utilizing this output to obtain an observed light intensity and then evaluating the BRDF at the intersection point. In some examples, the light intensity from the neural network is used directly as a light intensity value for evaluation of the BRDF. In other examples, the light intensity from the neural network is used more indirectly, to assist with selection of a light for sampling in a stochastic lighting technique. More particularly, in the stochastic technique, not all lights of a scene are evaluated in each frame. Instead, in each frame, a subset of such lights is sampled. To obtain a good representation of the lighting in the scene, the closest hit shader selects a light for such a stochastic technique with a probability based on relative intensity, where such intensity is the value output by the neural network. The more intense the light is, the more likely it will be to sample that light. In some examples, the probably of selecting a particular light is equal to the intensity of the light as output by the neural network divided by the sum of all light intensities as output by the neural network. In this instance, “sampling” the light involves calculating the actual intensity of the light at experienced at the intersection point, for example, by multiplying the inherent light intensity specified by the light (not output by the neural network) by the distance falloff factor. In these stochastic examples, the estimated light intensity is used simply as a representation of the relative importance of each light in a stochastic technique. It is possible to sample any number of lights less than the total number of lights in a scene, in the stochastic technique.

In some examples, a time-based smoothing operation is applied in the stochastic technique. In such an operation, the closest hit shader remembers the reflected radiance calculated at any given point on a surface (or within a particular region at any given point on a surface) in past frames and averages these reflected radiance values in the past frames with the reflected radiance calculated at the current frame. This time-based smoothing operation compensates for the variation that occurs with stochastic sampling of lights.

In another example, the closest hit shader uses the output from the neural network directly as the received light intensity, rather than using that value to sample one or more lights stochastically, and applies such a value to the BRDF to obtain the reflected radiance. In this scheme, the neural network predicts a received light intensity. In some such examples, the closest hit shader evaluates the BRDF for every light in the scene using the received light intensity predicted by the neural network and sums these values to obtain reflected radiance.

In the scene 500 of FIG. 5, the ray 506 cast from the camera is illustrated and an intersection point 508 on an intersected triangle 510(1) is illustrated as well. In addition, two other triangles—triangle 510(2) and triangle 510(3) are illustrated. Further, three light sources 512 are illustrated (specifically, light source 512(1), light source 512(2), and light source 512(3)). Additionally, three light source direction indicators 514 are illustrated (direction indicator 514(1), direction indicator 514(2), and direction indicator 514(3)).

The intersection 508 indicates that the ray 506 intersects the triangle 510(1) at the intersection point 508. In some examples, the ray tracing pipeline 300 causes a closest hit shader to be invoked in response to determining that this intersection is the closest intersection for the ray 506. This closest hit shader calculates lighting based at least in part on the technique described above related to sampling the neural network. In particular, the closest hit shader samples the neural network to obtain either shadow information or light intensity information, obtains light intensity incident on the intersection point 508 based on that information, calculates a direct lighting amount based on that light intensity, and calculates an overall lighting amount based on the direct lighting.

FIG. 6 illustrates an example system for determining lighting for ray tracing. An acceleration structure traversal stage 304 is traversing an accelerations structure (e.g., BVH) for a ray (such as ray 506, generated by a ray generation shader). The acceleration structure traversal stage 304 identifies a hit such as a closest hit and therefore invokes a closest hit shader 310, passing the ray and intersection information 602 (e.g., point of intersection) to the closest hit shader 310. The closest hit shader performs a variety of operations, including operations to color a pixel corresponding to a ray. Part of coloring this pixel includes determining lighting for the intersection. This lighting includes a direct lighting component, which is a contribution to the light for the intersection that is directly from light sources (as opposed to light reflected from non-light-source objects within the scene). Part of determining this direct lighting component includes applying the coordinates, of the point of intersection 604 of the ray with the surface for which the closest hit shader is intersected, to a lighting neural network 600. The lighting neural network 600 outputs lighting volumes 606 which include either an indication of whether a corresponding light source is occluded (also referred to as “in shadow” herein) or a value indicating the strength of a corresponding light as experienced at the intersection point. The closest hit shader 310 receives this information (the lighting values 606) and determines lighting and subsequently color for the pixel associated with the ray in operation 608, as described elsewhere herein. Although a closest hit shader 310 is described as performing these calculations, any other technically feasible entity, such as another shader program, a program executing on the processor 102, or hardware (e.g., circuitry) can perform these calculations.

As can be seen, a closest hit shader 310 utilizes a neural network to obtain lighting values to determine direct lighting for rays intersecting a scene. In order for the neural network to reflect information about the scene itself, the APD 116 or processor 102 periodically trains the lighting neural network 600 using information from the scene currently being rendered.

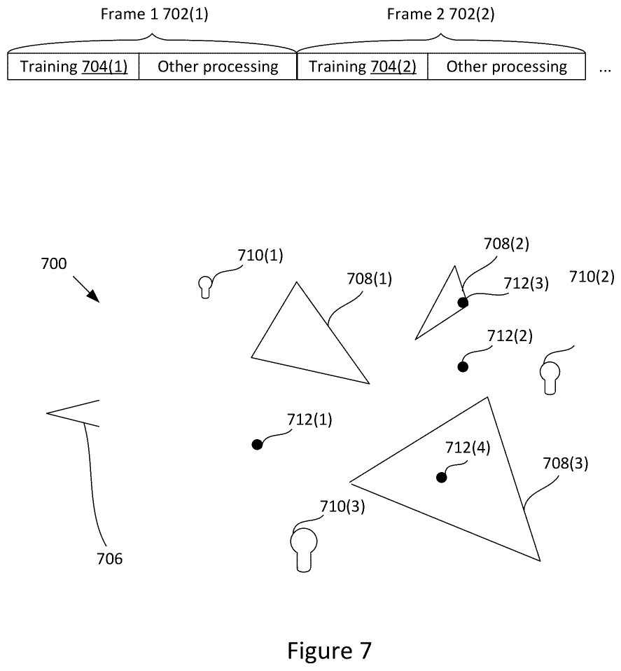

FIG. 7 illustrates an example set of training operations. In this example, training operations 704 occur in each frame 702 of a plurality of frames. The training operations include querying the scene 700 for a set of selected query points. The scene 700 includes a plurality of primitives 708 (e.g., surfaces), and a plurality of lights 710. The querying includes obtaining a result for each selected query point. A training system trains the lighting neural network 600 using the result and the selected query point. The result and selected query point, together, comprise a training data item. The training system includes any technically feasible system, such as software executing on the processor 102, software (e.g., a shader program) executing on the APD 116, hardware (e.g., circuitry) within the device 100, a combination of software of hardware, or any other technically feasible computing system. In some examples, the training system is the same compute shader that calculates lighting using the lighting neural network 600. Some example query points 712 are shown as well.

In an example where the lighting neural network 600 provides an indication of whether lights 710 are in shadow, each training data item includes a query point and an indication, for each light 710 in the scene, of whether that light 710 is visible from that query point. In some examples, to obtain this information for a query point, the training system casts a shadow ray from the query point to each light 710 to obtain an answer indicating whether that light 710 is occluded from that point. In an example, a shadow ray is a query of whether a ray extending from the query point to the light 710 intersects any opaque primitive 708 (e.g., an any hit shader executed for that ray determines whether the surface that triggered the any hit shader is opaque). Casting a shadow ray for each light 710 in the scene, for any given query point, thus gives an indication of whether each light 710 in the scene is visible from the query point. In this situation, the training data point includes the query point as input and the set of indications for each light 710 in the scene, for that query point.

In an example where the lighting neural network 600 provides an estimated intensity of each light at the query point, each training data item includes a query point as input and an indication, for each light 710 in the scene, of that estimated intensity. In some examples, to obtain this information for a query point, the training system casts a shadow from the query point to each to determine whether the light is occluded, in a similar manner as described above. Then, the training system calculates a light intensity at the sample point of each light source, for example by obtaining an intrinsic light intensity of the light source and modifying that intensity by a distance falloff factor. Thus each training data item includes the query point as well as an estimated light intensity for each light 710 in the scene, as experienced at the query point.

In another example, the lighting neural network 600 provides an estimate of the amount of light reflected from each light source 710 to the camera 706. In this situation, each output from the lighting neural network 600 is an estimate of the results of application of the intensity of a corresponding light to the BRDF of the material at the intersection point to obtain a reflected radiance. This reflected radiance is what is estimated by the output of the lighting neural network 600 in this example.

In summary, periodically, such as in each frame, the training system obtains a set of training data items by selecting a set of query points and analyzing how each light falls on each query point (e.g., whether the light is occluded, what the intensity of that light is at the query point, or what the reflected radiance is from that point to the camera 706. The training system applies that data to the lighting neural network 600 to train it.

In some examples, in each frame, the training system selects a set of query points to obtain the training data items for. In various examples, to select a point, the training system selects one primitive 708 in the scene randomly and selects one point on the surface of that primitive randomly. In some examples, in each frame, the training system selects one set of query points completely randomly (e.g., from a random point on a random surface in a scene) and selects another set of query points from among the portions of the primitives 708 that are actually visible by the camera 706 (e.g., does not select any point that is not visible to the camera 706). In some such examples, the set of query points includes one portion (e.g., one half, such as 1000 points out of 2000 points) that is visible to the camera and another portion that includes some points visible and some points not visible or even no points visible (e.g., the other half, such as the other 1000 points out of 2000 points). As a result, in each frame, the training system improves the accuracy of the lighting neural network 600 by continuing to train that neural network, for example once each frame (where each instance of training occurs with a set of samples, such as 2000 samples).

In some examples, training occurs through back-propagation. For each training data item, the training system applies the input to the lighting neural network 600 and observes the output of the lighting neural network 600. The training system compares the output of the lighting neural network 600 to the output specified by the item of training data and adjusts the weights of the training neural network 600 in a back-to front order as specified by the back-propagation technique. In some examples, the training neural network is a multi-layer perceptron with any technically feasible number of hidden layers, one neuron at the input to accept the input point, and one neural per light at the output to each provide the appropriate output as discussed elsewhere herein.

In some examples, the input to the neural network is an encoded version of the coordinates of the input point. In this example, a hash function is applied to the raw inputs (e.g., the coordinates) to obtain an index into the hash table. Values in the hash table begin as random values and are learned through the process of back propagation as part of the training of the neural network.

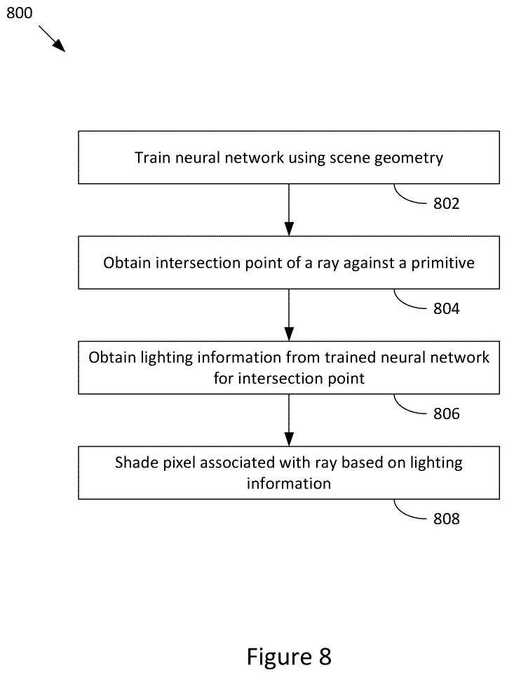

FIG. 8 is a flow diagram of a method 800 for performing ray tracing operations, according to an example. Although described with respect to the system of FIGS. 1-7, those of skill in the art will understand that any system configured to perform the steps of the method 800, in any technically feasible order, falls within the scope of the present disclosure.

At step 802, a training system (e.g., hardware, such as circuitry, software, such as a shader program, or a combination of hardware and software) trains a neural network (e.g., the lighting neural network 600) using scene geometry. As described elsewhere herein, this training involves obtaining a set of training data points and training the neural network based on these training data points. In general, each training data point has an input and a set of outputs, and training the neural network includes adjusting the weights of the neural network to minimize a cost function that describes the difference between the actual output of the neural network and the “expected output.” Here, the expected output when applying an input of a training data point to the neural network is the outputs of that training data point. As described elsewhere herein, in various examples, the training data items include as outputs, one of: an indication of whether a light source is occluded for the input point; an indication of the intensity of the light incident at the input point; or an indication of the intensity of the light reflected from the input point to a camera. In some examples, step 802 is performed once per frame, using a plurality of training data points generated from points selected randomly from the surfaces of primitives in the scene, where at least some such points are selected from the surfaces of primitives that are visible to the camera.

At step 804, the ray tracing pipeline 300 (e.g., via the acceleration structure traversal stage 304) obtains the intersection point of a ray against a primitive. In various examples, this intersection point is for a primitive for which lighting is to be calculated in order to render the scene. In some examples, this primitive is for the closest hit for the ray —that is, the closest primitive intersected by the ray. In some examples, such primitive is the closest hit opaque primitive. In some examples, the lighting calculation is performed for a primitive that is not necessarily the closest hit primitive but for which calculation of lighting information is needed regardless.

At step 806, the ray tracing pipeline 300 obtains lighting information from the lighting neural network 600 for the intersection point. In an example, this includes applying the intersection point as input to the lighting neural network 600, which outputs a set of lighting values, such as one lighting value for each light. In various examples, each lighting value is one of: an indication of whether the corresponding light is visible or in shadow; an indication of the intensity of the corresponding light source at the intersection point, or an indication of the intensity of the corresponding light source as reflected by the intersection point and seen from the camera (e.g., according to a BRDF).

At step 808, the ray tracing pipeline 300 shades a pixel associated with the ray based on the lighting information output by the lighting neural network 600. Any of a wide variety of technically feasible lighting techniques can be used to utilize the information output by the lighting neural network 600. In an example where the lighting neural network 600 outputs an indication of whether a light is occluded at the intersection point, the ray tracing pipeline 300 uses that information to determine whether to perform further operations to calculate a lighting contribution from that light to an overall lighting at the intersection point. More specifically, in some examples, calculating direct lighting at an intersection point includes calculating a contribution from one or more light sources and adding those contributions together. In some examples, the lighting amount calculated in one frame is averaged with lighting calculated in previous frames to reduce the amount of lighting calculations required in each frame. In some such examples, light sources are selected randomly based on the contribution of that light source to the intersection point. In some examples, the light source(s) selected in any particular frame are selected based on a probability density function, where light sources with a greater intensity (e.g., a greater intensity at the intersection point) are selected with greater probability than those with a lower intensity.

Thus, in some examples, the ray tracing pipeline 300 uses information output from the lighting neural network 600 as a means to select one or more lights for this calculation. In one example, the lighting neural network 600 outputs an indication of whether each light in the scene is visible at the point input to the lighting neural network 600. In this example, the ray tracing pipeline 300 selects one or more of the visible lights to perform further calculations with to obtain a direct lighting contribution for the intersection point in the current frame. In some examples, the ray tracing pipeline 300 calculates an “observed” intensity of each light source indicated as visible (e.g., reduces the intrinsic intensity of the light source by a distance falloff factor) and uses these values to select one or more light sources stochastically.

In one example, stochastic selection occurs by summing up all of the observed light sources for visible lights and assigning a probability to each light source based on its proportion of that summed value (e.g., the observed intensity of one light source divided by the sum of observed intensities). Then, the ray tracing pipeline 300 selects one or more such light sources, where any particular light source is selected with its assigned probability (e.g., a light source with 1/100 of total observed light intensity is selected 1% of the time). Subsequent to such selection, the ray tracing pipeline 300 performs further calculations, such as calculating the reflected radiance by evaluating the light source(s) using the BRDF of the material of the intersection point, and summing all of those reflected radiances to obtain a total. In examples where light sources are selected stochastically, this total is normalized by a factor that takes into account the fact that fewer than all light sources are selected in this frame (for where this normalization factor scales up the calculated value by a factor that represents the proportion of the calculated reflected radiance to an estimated total reflected radiance. This estimated total reflected radiance can be calculated based on the reflected radiances observed in previous frames or can be calculated based on an estimate of all reflected radiances for all light sources of the scene, where this estimate is much cheaper to calculate than the full BRDF factor (e.g., the estimate can be based on a simple scalar factor applied to the incident light intensity received from the light source, or can be calculated in any other way).

Above, it is stated that the lighting neural network 600 outputs an indication of whether a corresponding light is visible, but in other situations, the lighting neural network 600 outputs an estimate of the incident lighting intensity of each light source at the intersection point, or outputs an estimate of the reflected radiance of each light source at the intersection point. These values can be used in one of two ways. The values can be used in place of the calculated incident intensity to stochastically select one or more lights (with the probability density function based on the outputs from the lighting neural network 600, with higher values being selected with a higher probability) or the values can be directly used in calculating the final BRDF (e.g., directly if the lighting neural network 600 provides such values or by applying the BRDF for each light source if the lighting neural network 600 provides incident radiance).

Once the reflected radiance is obtained, this value is used in any technically feasible manner, such as by combining (e.g., multiplying) with a color sampled from the surface at the intersection point to produce an output value.

In some examples, steps 802-808 is performed in one frame and repeated every frame (or for multiple frames). In some examples, step 802 is performed once per frame and steps 804-808 are performed for each ray or for multiple rays in a frame.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the parallel processing units 138, the ray tracing pipeline 300, including the ray generation shader 302, acceleration structure traversal stage 304, any hit shader 306, hit or miss unit 308, closest hit shader 310, the miss shader 312, or the lighting neural network 600 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. Anything described as “circuitry” could alternatively be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
obtaining an intersection point of a ray against a primitive in a scene with a plurality of light sources;
applying the intersection point to a lighting neural network to obtain lighting information; and
shading a pixel corresponding to the ray using the lighting information.

2. The method of claim 1, further comprising training the lighting neural network each frame.

3. The method of claim 1, wherein the lighting neural network is configured to provide a plurality of lighting results as output.

4. The method of claim 3, wherein each lighting result is associated with a light source of the plurality of light sources.

5. The method of claim 4, wherein each lighting result specifies whether an associated light source of the plurality of light sources is visible at the intersection point.

6. The method of claim 4, wherein each lighting result specifies an intensity of an associated light source at the intersection point.

7. The method of claim 4, wherein each lighting result specifies a reflected radiance of an associated light source at the intersection point.

8. The method of claim 4, wherein shading the pixel includes selecting one or more light sources of the plurality of light sources stochastically with a probability density function based on the lighting result.

9. The method of claim 1, wherein shading the pixel includes determining a reflected radiance for the pixel based on the lighting result.

10. A system comprising:
a memory configured to store information for a lighting neural network; and
a processor configured to perform operations comprising:
obtaining an intersection point of a ray against a primitive in a scene with a plurality of light sources;
applying the intersection point to the lighting neural network to obtain lighting information; and
shading a pixel corresponding to the ray using the lighting information.

11. The system of claim 10, wherein the operations further comprise training the lighting neural network each frame.

12. The system of claim 10, wherein the lighting neural network is configured to provide a plurality of lighting results as output.

13. The system of claim 12, wherein each lighting result is associated with a light source of the plurality of light sources.

14. The system of claim 13, wherein each lighting result specifies whether an associated light source of the plurality of light sources is visible at the intersection point.

15. The system of claim 13, wherein each lighting result specifies an intensity of an associated light source at the intersection point.

16. The system of claim 13, wherein each lighting result specifies a reflected radiance of an associated light source at the intersection point.

17. The system of claim 13, wherein shading the pixel includes selecting one or more light sources of the plurality of light sources stochastically with a probability density function based on the lighting result.

18. The system of claim 10, wherein shading the pixel includes determining a reflected radiance for the pixel based on the lighting result.

19. A non-transitory computer-readable medium storing instructions that, when executed by a processor, cause the processor to perform operations comprising:
obtaining an intersection point of a ray against a primitive in a scene with a plurality of light sources;
applying the intersection point to a lighting neural network to obtain lighting information; and
shading a pixel corresponding to the ray using the lighting information.

20. The non-transitory computer-readable medium of claim 19, wherein the operations further comprise training the lighting neural network each frame.
